(19) United States
(12) Patent Application Publication
(10) Pub. No.: US 2008/0320002 A1
(43) Pub. Date: Dec. 25, 2008

(54) Method of Providing Information

(75) Inventors: Maarten Peter Bodlaender, Eindhoven (NL); Albertus Josephus Breemen, Lommel (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,329

(22) PCT Filed: Sep. 14, 2005
(86) PCT No.: PCT/IB05/53016

§ 371 Date: Mar. 15, 2007

(30) Foreign Application Priority Data
Sep. 21, 2004 (EP) 04104570.9

(51) Int. Cl. G06F 17/30

(52) U.S. Cl. 707/10; 707/E17.001

(57) ABSTRACT

The invention relates to a method (100, 200, 300, 400) wherein a value of compliance between a number of profiles (PF) containing constraints, that should be satisfied, and a plurality of content items (CI) is generated. It is well known to generate a value of compliance, a so-called distance, between a single content item and a profile. However, by comparing a plurality of content items (CI) with a number of profiles (PF) enhanced information regarding the characteristics of the profiles (PF) as well as of the plurality of content items (CI) is achieved. This could be used to automatic archiving of content items in storage structures associated with certain profiles (PF), to aid users in creation of sub-collections, to aid users in assessing and improving the quality of sub-collections and of collections. The invention moreover relates to equipment and a program for performing the method and a storage medium having such a program stored thereon.

### FIELD OF THE INVENTION

This invention relates to a method of providing information.

The invention further relates to a consumer electronic equipment.

The invention further relates to a program product.

The invention further relates to a medium readable by a consumer electronic device.

### BACKGROUND OF THE INVENTION

Consumers increasingly store their digital content items in collections, for example on hard disks or solid-state memories. Examples of such content items could be music, text, video (clips), pictures, etc. The devices storing these content items typically have support for sub-collections, e.g. play lists (in the case of music collections), slide shows (in the case of picture collections), etc. Users can either manually create such sub-collections or algorithms can automatically generate such sub-collections by the use of a number of constraints that typically can be user-defined. One way of specifying constraints is the user selecting or creating a profile comprising all relevant constraints. A generated sub-collection should satisfy the constraints in the profile. The constraints could be one or more of the following:

Constraints defined on individual items in the collection;

Constraints defined on relations between items in the collection;

Constraints defined on the collection as a whole.

For constraints defined on individual items in the collection, the constraints are individually checked for each item in a collection. If all individual checks are met, the collection fulfils the constraints. For example, a constraint relating to a music item could be “song genre=pop”.

For constraints defined on relations between items in the collection, the constraints are checked for any set of items in the collection. Such constraints can relate to the presence/absence of items related to each other as well as the order in which the items appear in an ordered collection. Examples of such constraints relating to music items could be “if song with ‘genre=classic’ in collection no song with ‘genre=pop’ in collection” or “two neighbouring songs cannot have same artist”.

For constraints defined on the collection as a whole, the constraints are checked for the total collection. An example of such a constraint could be “total length of all songs 50 minutes”.

It is well known to define profiles, such that a measure for the compliance, a so-called distance, between a collection and a profile can be calculated. If the distance is 0, the collection fully matches the profile, i.e. fulfils the constraints indicated in the profile. If the distance is greater than zero, the collection only partially fulfils the constraints indicated in the profile. Typically, when automatically generating a sub-collection based on a profile, the generation algorithm minimizes the distance, but always provides a result even if it is not possible to generate a sub-collection fulfilling the constraints indicated in the profile.

A multitude of documents regarding the generation of playlists is published, e.g. “Scaling up music playlist generation” by J-J Aucouturier and F Pachet, “Realization and User Evaluation of an Automatic Playlist Generator” by S Pauws et al., and “Content-Based play list generation: Exploratory Experiments”, International Conference on Music Information Retrieval (SIMIR 2002), October 2002, by B Logan.

J-J Aucouturier and F Pachet describe a system for automatic generation of music playlists out of large music catalogues. The system uses a computation of how well constraints are matched by individual items in a possible playlist to form a playlist containing those items that together create the best match in relation to the constraints.

S Pauws et al. describe generating playlist based on similarities between songs. Clusters of songs are formed, and a playlist can be generated by choosing songs constituting the cluster of a selected song. Moreover, the playlist can be improved by user feedback in relation to whether songs in a playlist fit the desire of the user.

B Logan describes a system and method of improving automatically generated playlists. This is done by use of a distance measure between songs so that the total distance between N songs in a playlist is minimized. Moreover, the generated playlists can be improved by means of automatic relevance feedback.

### OBJECT AND SUMMARY OF THE INVENTION

It is an object of the invention to provide a method of providing information regarding already existing collections or playlists so that the quality thereof can be assessed more easily. In this regard, the term “quality” is meant to denote to which degree a set of defined constraints are fulfilled. This use of the term “quality” typically correlates strongly with the general use of the word, so that when the set of defined constraints is fulfilled to a high degree, the collection will be experienced as having a high quality by a user having set up the constraints to match his/her wishes.

The invention achieves the above object by providing a method of providing information on the compliance of a plurality of content items in a collection of content items in relation to profiles, wherein the method comprises the steps of (a) calculating a value of compliance between the plurality of content items and a profile based on calculations of a value of compliance between each of the content items and the profile; (b) performing step (a) for a plurality of profiles; and (c) determining the X profiles having the best value of compliance with the plurality of content items.

Thus, the invention concerns the provision of information regarding a comparison between a plurality of content items and a plurality of profiles instead of only providing information regarding how well a single collection of content items match a single profile. Thus, information can be provided rendering it possible to get insight into characteristics of a plurality of content items, finding those pluralities of content items best matching the intents/desires of users, etc. The number X of profiles to be outputted could be predetermined or could be input by a user.

Preferably, the method further comprises the step of (d) outputting the determined X profiles. Hereby, improved user feedback is provided regarding the characteristics and/or quality of the content items and profiles. This can provide a better user experience.

In a preferred embodiment the method of the invention further comprises outputting the value of compliance between the plurality of content items and the determined X profiles. Thus, the profiles can readily be compared. Moreover, this output values give indications of the possibility of making a sub-set of the plurality of the content items with a high value of compliance with the profiles. Especially, if the plurality of content items in the collection of content items contains all content items, the value of compliance is a value of compliance between the whole collection and a number of profiles; in this case the output values of compliance indicates the possibility of making a sub-collection with a high value of compliance with the profiles and/or how many different high quality sub-collections can be generated. In the case of a music collection, such value could indicate the possibility of making a sub-collection of classical music, pop music as well as rock music.

In another preferred embodiment, the method of the invention comprises, for each of the determined X profiles, further outputting information regarding which content item in the plurality of content items in the collection provides the best and/or worst value of compliance with the profile. Hereby, users can be aided to manually adapt sub-collections (i.e. pluralities of content items) that fulfil constraints in profiles and thereby improve compliance between a plurality of content items and a profile.

In yet another preferred embodiment, the method of the invention comprises, for each of the determined X profiles, further outputting information regarding a content item, which is not comprised in the plurality of content items and which upon inclusion in the plurality of content items would improve the value of compliance between the plurality and the profile. This feature implies knowledge of content items not comprised in the collection. Such knowledge could e.g. be achieved from content providers via the Internet. To this end the method could comprise the step of connecting to the Internet. Thus, a user can be recommended to buy or otherwise achieve content items that would improve the compliance between a collection and a profile.

In yet another preferred embodiment, the method of the invention further comprises the steps of: (e) comparing the calculated value of compliance between the plurality of content items and the profiles with a predetermined threshold value; and (f)/(f′) storing the plurality of content items/a reference thereto in any storage structure associated with the profiles. References to the plurality of content items can for example be stored in a playlist file format like M3U. An example of a profile with associated storage structure is a data structure that describes the profile and that includes a reference to the location of the playlist, where the playlist in turn contains references to content item locations. Hereby, search times searching for content items in storage structures associated with profiles can be shortened.

Preferably, the method of the invention further comprises the steps of: (g) determining whether any profile in the plurality of profiles comprises a constraint the fulfilment of which can vary in dependence of events occurring, and for any such profile, determining which events might influence the fulfilment of the constraint; and (h) recalculating the value of compliance between any such profile and the plurality of content items upon occurrence of such an event. Hereby, the value of compliance for the profiles in the plurality of profiles can be updated continuously, which renders it possible that the determination of the X profiles having the best value of compliance with the plurality of content items is updated at any time.

In a preferred embodiment, the event above could be the passing of a time interval and/or the presentation of a content item. Hereby, the method could comprise the steps of determining whether any profile in the plurality of profiles comprises a constraint, the fulfilment of which is variable in time, and for any such profile comprising such a constraint, determining the time interval by which the fulfilment of the constraint can vary; and recalculating the value of compliance between any such profile and the plurality of content items at intervals corresponding to the shortest time interval of the determined time intervals. Such intervals could be hours, days, years, etc. or could be correlated to the time intervals at which “top30” is updated. Alternatively or additionally, a preferred embodiment of the method could comprise the steps of determining whether any profile in the plurality of profiles comprises constraints, the fulfilment of which is variable in dependence of presentation of content items; and recalculating the value of compliance between any such profile and the plurality of content items, whenever a number Y of content items has been presented. Thus, the method can take into account, if the value of compliance depends on e.g. the number of times a content item has been presented.

The method can preferably be arranged to be performed in a consumer electronic (CE) equipment, preferably a consumer electronic equipment already comprising a profile-based playlist generator. Hereby, algorithms already available in the CE equipment might be reused for performing the method of the invention.

The invention moreover regards a consumer electronic equipment, a program product and a medium readable by a consumer electronic device and having a program product stored thereon presenting equivalent advantages and features as the method described above.

It should be noted that the term “consumer electronic equipment” is meant to indicate any electronic device or any component of an electronic device, including, but not limited to, computers, computer peripherals, radio equipment, stereo equipment, CD players/recorders, DVD players/recorders, PDAs, MP3-players, mobile phones.

Moreover, the term “content item” can be any piece of audio and/or visual content, such as music, video, text, etc. The term “collection” should be understood as all the content items available and the term “sub-collection” as a sub-part of a collection, i.e. typically a plurality of content items in a collection. A “profile” is a set of constraints, which might be set manually by a user or automatically. Moreover, in the case of a collection of music items, a list of the items in a sub-collection is termed “playlist”. Finally, it should be noted that throughout this specification, the word “plurality” is meant to denote two or more.

### BRIEF DESCRIPTION OF THE DRAWINGS

The invention will be explained more fully below in connection with a preferred embodiment, but to which the invention is not limited, and with reference to the drawing, in which:

FIGS. 1 to 4 show flow diagrams of methods according to the invention, and

FIG. 5 is a schematic diagram of the structures used in the methods of the invention.

### DESCRIPTION OF EMBODIMENTS

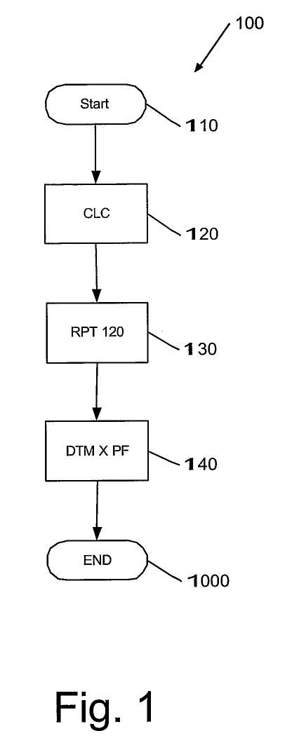

FIG. 1 shows a flow diagram of a method 100 according to the invention. In the examples of methods of the invention explained in the following, the content items are pieces of music and it is assumed, that the methods are carried out in consumer electronic (CE) device as e.g. a MP3-player, PDA with audio output facilities. However, of course the methods should not be regarded as limited to these examples.

The flow starts in step 110. Input parameters to the flow comprise data of a plurality of content items (CI), i.e. pieces of music, in a collection (C) of content items (CI) and a plurality of profiles (PF). The data of the pieces of music can include one or more of the following: name of artist, title of the piece of music, genre, year of release, tempo, a list of musicians, producer, and current placement in relevant music charts (e.g. “top 40”).

The flow continues to step 120, where a value of compliance between the plurality of pieces of music and a profile is calculated on the basis of known calculations of a value of compliance between each of the pieces of music and the profile. Thus, the profile is compared with the whole sub-collection of pieces of music.

The next step, step 130, consists of a repetition of step 120 for a plurality of profiles. This plurality could consist of virtually any number of profiles, but typically of the range below ten or a few tens of profiles.

In the next step, step 140, it is determined which X profiles have the best value of compliance with the plurality of pieces of music, where X is an integral number. Examples of typical values of X could be 3 or 5. Hereby, it is determined which of the profiles have the best compliance with the sub-collection containing the plurality of content items/pieces of music. If this is performed for a plurality of sub-collections, this can be used to obtain insight in the characteristics of the different sub-collections, to find a sub-collection that matches the wishes of as many different persons as possible (if each person e.g. establishes one profile), to make sure that the sub-collection comprises music to match everybody's wishes, etc. The flow ends in step 1000.

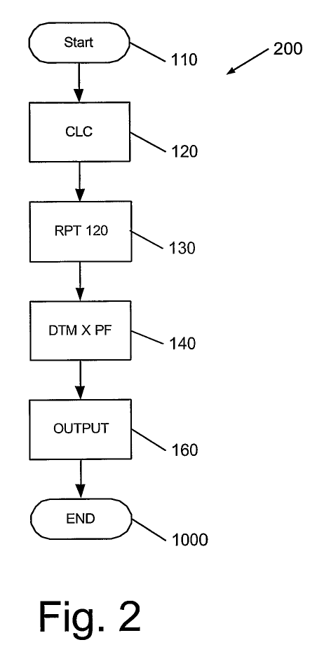

The methods 200, 300 and 400, respectively, shown in FIGS. 2, 3 and 4, respectively, are all further developments of the method 100 and thus the methods 200, 300 and 400 all comprise the steps 110 to 140 of method 100; these steps are therefore not explained again.

FIG. 2 shows a flow diagram of another method 200 according to the invention. As mentioned above, the method starts in step 110 and the steps 120 to 140 follows as in the method 100. The step 140 is succeeded by step 150, wherein the determined X profiles are output, typically on a display of the CE device. Hereby, a user of the CE device can see which profiles best matches a sub-collection/playlist. In addition to the advantages mentioned above, this function might be used in a game wherein one or more users are given a random set of songs and a limited time to create a playlist. Subsequently, the best playlist could be chosen for actual playback. Again, the flow ends in step 1000.

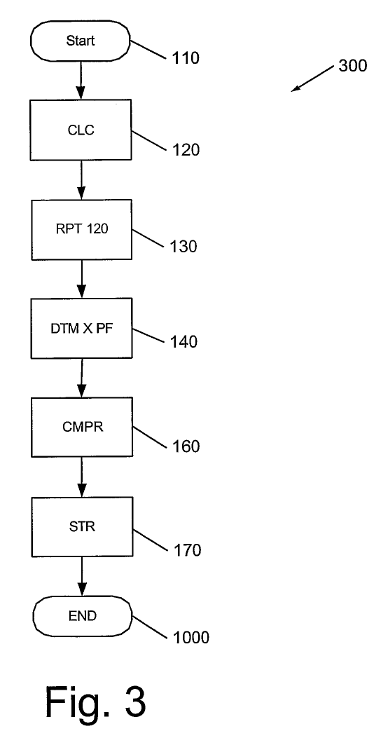

FIG. 3 shows a flow diagram of another method 300 according to the invention. As mentioned above, the method starts in step 110 and the steps 120 to 140 follows as in the method 100. The step 140 is succeeded by step 160, wherein the calculated value of compliance between the plurality of pieces of music and the profiles are compared with a predetermined threshold value. For each profile for which the calculated value of compliance is above the threshold, the plurality of pieces of music or references thereto are stored in any storage structure associated with the profile. Again, the flow ends in step 1000.

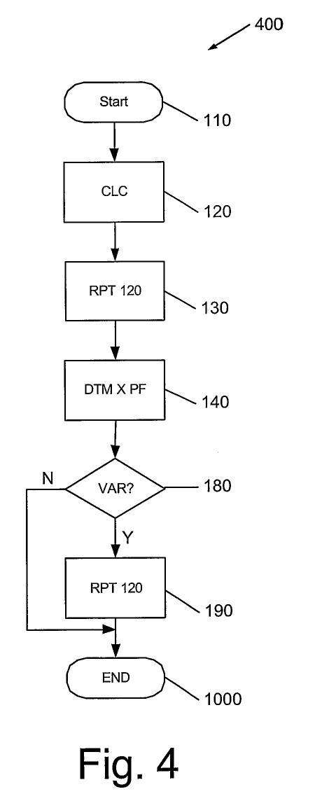

FIG. 4 shows a flow diagram of yet another method 400 according to the invention. As mentioned above, the method starts in step 110 and the steps 120 to 140 follows as in the method 100. The step 140 is succeeded by step 180, wherein it is determined whether any profile in the plurality of profiles comprises a constraint the fulfilment of which can vary in dependence of events occurring and, for any such profile, it is determined, which event(s) might influence the fulfilment of the constraint. If no such profiles exist, the flow ends in step 1000. However, if any such profile exists, step 120 is repeated for this/those profiles upon occurrence of such an event. This step naturally implies listening for and/or registering such an event as well. Hereby, the frequency of recalculations becomes closely related to the characteristics of the constraints in the profiles. Examples of the events are the change of date (if a profile comprises a constraint regarding the age of the piece of music), the change of a music chart (e.g. “Top 10”), the playback of a piece of music a certain amount of times, etc. After step 190, the flow ends in step 1000.

It should be noted, that even though the step 150, the step 160 together with 170 and the step 180 together with 190 are shown and explained as three different extensions of the method 100, any combination of these three extensions (including all of them) could be used as an extension of the method 100.

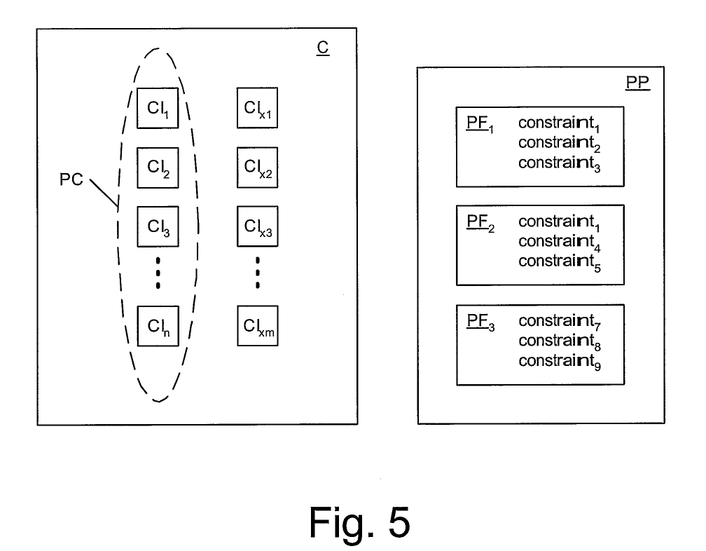

FIG. 5 is a schematic diagram of the structures used in the methods of the invention. A plurality of content items CI is shown with references “CIᵢ”. Each such content item could e.g. be a piece of music, video or text. The totality of all the content items constitutes the collection C. The ellipse drawn in broken line contains a plurality PC of content items CI. Typically, the collection C comprises a huge number of content items, in that the collection could be all the pieces of music in a music collection, pieces of music in a music catalogue, e.g. on a homepage of a music provider, films or scenes of films in a film catalogue, a multitude of photos taken over a plurality of years, etc. Moreover, a number of profiles PF are shown with references PFⱼ. Each profile contains a number of constraints referenced “constraintₙ”. As mentioned above, such constraints can be one or more of the following:

Constraints defined on individual items in the collection;

Constraints defined on relations between items in the collection;

Constraints defined on the collection as a whole.

The plurality of profiles PFj is denoted PP.

### EXAMPLES

In the following, examples of output by use of the method of the invention are given.

In the case of feedback on a certain collection of pieces of music, the output could be:

TABLE 1

| Score | Profile | Worst matching song |
|---|---|---|
| 55% | Happy poppy dance | Waarheen leidt de weg |
| 33% | Rock & grunge | The ketchup song |
| 25% | Joe's lounge music | Waarheen leidt de weg |
| 11% | Calm Classic | Smells like teen spirit |

Table 1 shows the output when a playlist/collection of pieces of music is matched with different profiles. In this case a value of compliance (“Score”) is shown for four profiles. For each profile the worst matching song is indicated as well.

TABLE 2

| Suitability | Profile | Best matching song | Extend with: |
|---|---|---|---|
| 95% | Happy poppy dance | The ketchup song | Shakira |
| 93% | Rock & grunge | Smells like teen spirit | Aerosmith |
| 81% | Calm classic | Waarheen leidt de weg | Janni |

Table 2 shows feedback regarding the possibility to create a sub-set of a plurality of content items rendering a high value of compliance. In this case the value of compliance is denoted “Suitability” to indicate that it is an assessment of whether a number of content items/songs can be chosen from the plurality of content items/songs so that this sub-collection has a high value of compliance with the profiles, i.e. whether the plurality of content items is suitable with regard to the profiles and/or whether there is sufficient diversity in possibilities for creating sub-collections. In the case in Table 2, recommendations of artists, who generally make music in a genre corresponding to the appropriate profiles are indicated in the last column (“Extend with:”). The output of Table 2 could e.g. be used to assess whether a collection of music items contains music corresponding to the tastes of different persons.

Algorithm

In the following an example of an embodiment is given. It is assumed, that the method of the invention is carried out in a CE device comprising an algorithm MEET (i, j) giving as output a value indicating to which extent a content item i meets the constraint j.

On the basis of MEET (i, j) an algorithm ALG1 can be formed. ALG1 has a plurality PC of content items CI and a profile PF as input and produces as output a value of compliance indicating how well the plurality PC matches the profile PF. Moreover, the algorithm ALG1 could output a number of individual and/or ordered content items of the plurality PC that are the most responsible for decreasing and/or increasing the quality of match, i.e. the value of compliance. One possible embodiment is that ALG1 calculates the percentage of all met constraints in the profile PF.

For example, for each individual constraint CS [1 . . . n] in the profile PF and each individual content item CI [1 . . . k] in the plurality PC of content items it can be calculated to which extent the content item CI meets the constraint CS by means of the algorithm MEET (i, j) and a value of compliance can be calculated as

$$100 * {\sum }_{\begin{matrix}CI ∈ [ 1 … k ] \\ CS ∈ [ 1 … n ]\end{matrix}} \frac{MEET ( i , j )}{n * k}$$

The content items CI, which violate most individual constraints, e.g. contributes most negatively to the value of compliance between the plurality PC of content items CI as a whole and the profile PF, can be found by calculating, for each content item CI, i, the metric sum (i in [1 . . . n]: not MEET (i,j)).

The above can be generalized to also include constraints that relate to ordered sub-sets of content items. It can further be generalized by weighing the different constraints differently. It can further be generalized by specifying that a number of constraints are constraints that MUST be satisfied, so that the quality/value of compliance is equal to 0 if these constraints are not satisfied. Moreover, the above could be generalized so that certain constraints can be partially met, which changes the algorithm MEET (i, j) from a function with an output of 0 or 1 to an function with an output between 0 and 1 (both included).

The method of the invention can be used in an application for managing a content collection (e.g. music collection), editing profiles and generating playlists in a CE device with a display. The content items in the content collection can be listed and a profile can be selected, e.g. in a drop down menu. When a profile is selected, the content items are coloured to indicate their relevance with regard to the profile. E.g. the content items having a positive relevance could be coloured in one colour, the content items having a negative relevance could be coloured in another colour and the content items for which no relevance is defined could be coloured in a third colour. The application might as well be able to indicate the suitability of the collection for the playlist generation with regard to the selected profile. The profiles could be extensible so that users and/or external parties could add and/or modify profiles or they could be formed by learning algorithms. Of course, the feedback from the application could be on manually created playlists either during or after creation.

1. A method of providing information on the compliance of a plurality (PC) of content items (CI) in a collection (C) of content items (CI) in relation to profiles (PF), wherein said method comprises the steps of:
(a) calculating a value of compliance between said plurality (PC) of content items (CI) and a profile (PF) based on calculations of a value of compliance between each of said content items (CI) and said profile (PF);
(b) performing step (a) for a plurality (PP) of profiles (PF); and
(c) determining the X profiles (PF) having the best value of compliance with said plurality (PC) of content items (CI).

2. A method according to claim 1, characterized in further comprising the step of:
(d) outputting the determined X profiles.

3. A method according to claim 1, characterized in further outputting the value of compliance between said plurality (PC) of content items (CI) and the determined X profiles.

4. A method according to claim 1, characterized in, for each of said determined X profiles, further outputting information regarding which content item (CI) in the plurality (PC) of content items (CI) in the collection (C) provides the best and/or worst value of compliance with the profile (PF).

5. A method according to claim 1, characterized in, for each of said determined X profiles, further outputting information regarding a content item (CI), which is not comprised in said plurality (PC) of content items (CI) and which upon inclusion in the plurality (PC) of content items (CI) would improve the value of compliance between said plurality (PC) and the profile (PF).

6. A method according to claim 1, characterized in further comprising the steps of:
(e) comparing the calculated value of compliance between said plurality (PC) of content items (CI) and the profiles (PF) in the plurality (PP) of profiles (PF) with a predetermined threshold value; and
(f) for each profile (PF) for which the calculated value of compliance is above said threshold, storing said plurality (PC) of content items (CI) in any storage structure associated with said profile (PF).

7. A method according to claim 1, characterized in further comprising the steps of:
(e′) comparing the calculated value of compliance between said plurality (PC) of content items (CI) and the profiles (PF) in the plurality (PP) of profiles (PF) with a predetermined threshold value; and
(f′) for each profile (PF) for which the calculated value of compliance is above said threshold, storing a reference to said plurality (PC) of content items (CI) or to each content item in said plurality (PC) of content items (CI) in any storage structure associated with said profile (PF).

8. A method according to claim 1, characterized in further comprising the steps of:
(g) determining whether any profile (PF) in the plurality (PP) of profiles comprises a constraint the fulfilment of which can vary in dependence of events occurring, and for any such profile, determining which event(s) might influence the fulfilment of the constraint; and
(h) recalculating said value of compliance between any such profile (PF) and said plurality (PC) of content items (CI) upon occurrence of such an event.

9. A method according claim 8, characterized in that said event is the passing of a time interval and/or the presentation of a content item (CI).

10. A method according to claim 1, characterized in that it is arranged to be performed in a consumer electronic equipment.

11. A method according to claim 1, characterized in that the content items are music pieces and that the plurality of content items is the music pieces of a playlist.

12. A consumer electronic equipment arranged to perform the method according to claim 1.

13. A consumer electronic equipment according to claim 12, characterized in that it comprises a profile-based playlist generator.

14. A consumer electronic equipment according to claim 12, characterized in that it has means for connection to a network.

15. A program product directly loadable into a memory of a consumer electronic device, characterized in that it comprises software code portions for performing the method according to claim 1 when said product is executed in a consumer electronic device.

16. A medium readable by a consumer electronic device and having a program product stored thereon, where the program product is arranged to make the consumer electronic product execute the method according to claim 1.
